(19) United States
(12) Patent Application Publication
(10) Pub. No.: US 2026/0175807 A1
(43) Pub. Date: Jun. 25, 2026

(54) WARNING DEVICE

(71) Applicants: TOYOTA JIDOSHA KABUSHIKI KAISHA, Aichi-ken (JP); DENSO CORPORATION, Aichi-pref (JP)

(72) Inventors: Masaho ISHIDA, Toyota-shi (JP); Hiroaki IIDA, Hashima-shi (JP); Haruki HIRASAWA, Nagoya-shi (JP); Issei MATSUNAGA, Owariasahi-shi (JP)

(21) Appl. No.: 19/403,233

(22) Filed: Nov. 28, 2025

(30) Foreign Application Priority Data
Dec. 25, 2024 (JP) 2024-229375

(51) Int. Cl. B60R 21/0134; B60W 50/14

(52) U.S. Cl. CPC B60R 21/0134; B60W 50/14; B60W 2552/53

(57) ABSTRACT

The warning device includes a processor configured to set a warning target region on a rear-lateral side of a vehicle, and notify an occupant of the vehicle of a warning when a moving object located in the warning target region is expected to come into contact with a door of the vehicle. The processor is configured to set a predetermined area in a vehicle coordinate system based on the vehicle to the warning target region, and correct the predetermined area when the vehicle is obliquely stopped with respect to a white line of a road.

### FIELD

The present disclosure relates to a warning device.

### BACKGROUND

Conventionally, a technique for alerting an occupant of the presence of a moving object approaching a vehicle when there is a possibility that an occupant of the vehicle gets off is known. In the technique described in PTL 1, an alarm area having a side surface of a stopped vehicle as a boundary line is set, and an alarm is given to an occupant of the vehicle when a moving object in the alarm area is expected to come into contact with a door of the vehicle.

### CITATIONS LIST

### Patent Literature

[PTL 1] Japanese Unexamined Patent Publication No. 2022-048511

### SUMMARY

### Technical Problem

However, the vehicle does not necessarily stop parallel to the white line of the road. When the vehicle is obliquely stopped with respect to the white line of the road, in the present disclosure described in PLT 1, the position of the alarm area changes according to the stop angle of the vehicle. As a result, there is a possibility that a moving object that may come into contact with the door of the vehicle is out of the alarm area, and the moving object which should be made the warning target is excluded from the warning target.

In view of the above problem, an object of the present disclosure is to suppress a moving object that may come into contact with a door of a vehicle from being excluded from a warning target when the vehicle is obliquely stopped with respect to a white line of a road.

### Solution to Problem

The summary of the present disclosure is as follows.
(1) A warning device comprising a processor configured to: set a warning target region on a rear-lateral side of a vehicle; and notify an occupant of the vehicle of a warning when a moving object located in the warning target region is expected to come into contact with a door of the vehicle, wherein the processor is configured to set a predetermined area in a vehicle coordinate system based on the vehicle to the warning target region, and correct the predetermined area when the vehicle is obliquely stopped with respect to a white line of a road.
(2) The warning device described in above (1), wherein the processor is configured to enlarge the predetermined area when the vehicle is obliquely stopped with respect to the white line.
(3) The warning device described in above (2), wherein the predetermined area is defined by a vehicle side boundary line forming a predetermined angle with respect to an imaginary line parallel to a side surface of the vehicle, the processor is configured to enlarge the predetermined area so that the vehicle side boundary line forms a correction angle larger than the predetermined angle with respect to the imaginary line when the vehicle is obliquely stopped with respect to the white line, and the correction angle is a sum of an increment angle equal to or less than an angle that the vehicle forms with respect to the white line, and the predetermined angle.
(4) The warning device described in above (2), wherein the predetermined area is defined by an intersection determination line extending away from the vehicle in a width direction of the vehicle, and a vehicle side boundary line extending from an end point on the vehicle side of the intersection determination line to a rear of the vehicle, and when the vehicle is obliquely stopped with respect to the white line, the processor is configured to extend the intersection determination line toward the vehicle side so that an end point on an opposite side to the vehicle of the vehicle side boundary line approaches a corresponding end point of the warning target region when it is assumed that the vehicle is stopped parallel to the white line.
(5) The warning device described in above (1), wherein when the vehicle is obliquely stopped with respect to the white line, the processor is configured to rotationally move the predetermined area by a predetermined rotation angle so that the predetermined area overlaps with the warning target region when it is assumed that the vehicle is stopped parallel to the white line, and the rotation angle is equal to or less than an angle that the vehicle forms with respect to the white line.

According to the present disclosure, it is possible to suppress a moving object that may come into contact with a door of a vehicle from being excluded from a warning target when the vehicle is obliquely stopped with respect to a white line of a road.

### BRIEF DESCRIPTION OF DRAWINGS

FIG. 1 is a schematic configuration diagram of a warning system including a warning device according to an embodiment of the present disclosure.

FIG. 2 is a diagram showing a rear portion of the vehicle.

FIG. 3 is a diagram showing a predetermined area set to the warning target region.

FIG. 4A is a diagram for explaining a problem that occurs when the vehicle is obliquely stopped with respect to the white line.

FIG. 4B is a diagram for explaining a problem that occurs when the vehicle is obliquely stopped with respect to the white line.

FIG. 5A is a diagram showing a specific example of a method for correcting the predetermined area.

FIG. 5B is a diagram showing a specific example of a method for correcting the predetermined area.

FIG. 6A is a diagram showing a specific example of a method for correcting the predetermined area.

FIG. 6B is a diagram showing a specific example of a method for correcting the predetermined area.

FIG. 7A is a diagram showing a specific example of a method for correcting the predetermined area.

FIG. 7B is a diagram showing a specific example of a method for correcting the predetermined area.

FIG. 8 is a flow chart showing a control routine relating to the warning process in the present embodiment.

### DESCRIPTION OF EMBODIMENTS

Hereinafter, embodiments of the present disclosure will be described in detail with reference to the drawings. In the following description, the same reference numerals are given to the same constituent elements.

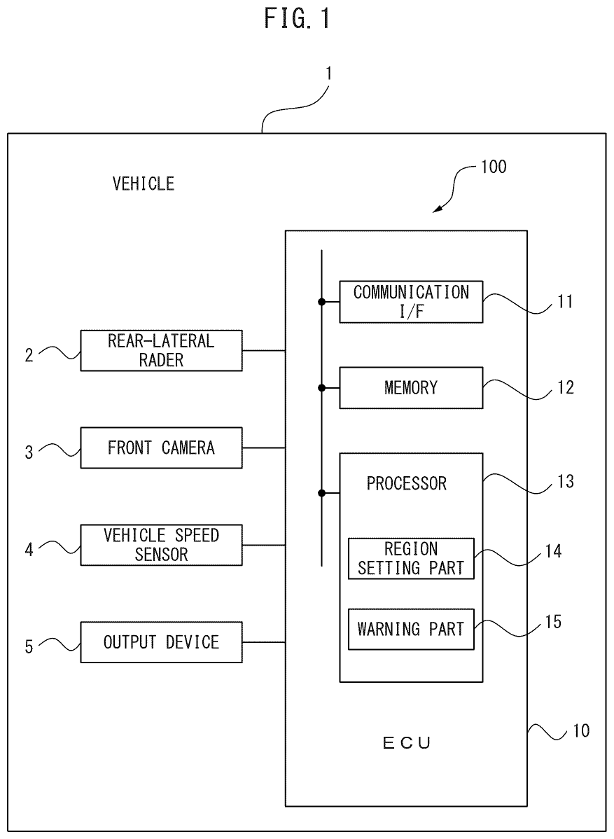

FIG. 1 is a schematic configuration diagram of a warning system 100 including a warning device according to an embodiment of the present disclosure. The warning system 100 is mounted on the vehicle 1, and notifies an occupant (for example, a driver) of the vehicle 1 of a warning as necessary. In the present embodiment, the vehicle 1 is a four-wheeled car.

As shown in FIG. 1, the warning system 100 includes a rear-lateral radar 2, a front camera 3, a vehicle speed sensor 4, an output device 5 and an electronic control unit (ECU) 10. The rear-lateral radar 2, the front camera 3, the vehicle speed sensor 4, and the output device 5 are electrically connected to the ECU 10 via an in-vehicle network or the like compliant with a standard such as CAN (Controller Area Network) or Ethernet.

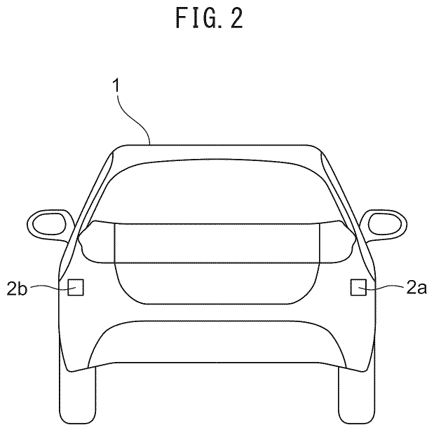

The rear side radar 2 irradiates the rear-lateral side of the vehicle 1 with millimeter waves, and acquires reflected waves of millimeter waves as data for detecting an object on the rear-lateral side of the vehicle 1. In the present embodiment, as shown in FIG. 2, the rear-lateral radar 2 has a right rear-lateral radar 2a and a left rear-lateral radar 2b. The right rear-lateral radar 2a is provided at the right rear corner of the vehicle 1, and irradiates the right rear-lateral side of the vehicle 1 with millimeter waves. The left rear-lateral radar 2b is provided at the left rear corner of the vehicle 1, and irradiates the left rear-lateral side of the vehicle 1 with millimeter waves. The output of the rear-lateral radar 2, i.e. data of the reflected waves acquired by the rear-lateral radar 2, is transmitted to the ECU 10.

The front camera 3 captures an image of the front of the vehicle 1 and generates an image of the front of the vehicle 1. For example, the front camera 3 is provided above a room mirror of the vehicle 1 or on a central upper part of a windshield. The output of the front camera 3, i.e. the images generated by the front camera 3, is transmitted to the ECU 10.

The vehicle speed sensor 4 detects the speed of the vehicle 1. For example, the vehicle speed sensor 4 detects the speed of the vehicle 1 by detecting the rotational speed of the wheels of the vehicle 1. The output of the vehicle speed sensor 4, i.e., data of the speed of the vehicle 1 detected by the vehicle speed sensor 4 is transmitted to the ECU 10.

The output device 5 notifies the occupant of the vehicle 1. The output device 5 includes at least one of a display, a warning light, a speaker, a buzzer, and a vibration unit. The output device 5 notifies the occupant of an output corresponding to the signal transmitted from the ECU 10.

The ECU 10 executes various controls of the vehicle 1. As shown in FIG. 1, the ECU 10 includes a communication interface 11, a memory 12 and a processor 13. The communication interface 11 and the memory 12 are connected to the processor 13 via a signal line. In the present embodiment, one ECU 10 is provided, but a plurality of ECUs may be provided for various functions. In addition, the communication interface 11, the memory 12, and the processor 13 may be configured as one integrated circuit, or may be configured as separate circuits.

The communication interface 11 has an interface circuitry for connecting the ECU 10 to the in-vehicle network. The ECU 10 is connected to other in-vehicle devices via the communication interface 11. The communication interface 11 transmits signals received from the rear-lateral radar 2, the front camera 3, and the vehicle speed sensor 4 to the processor 13. Further, the communication interface 11 transmits the signal output from the processor 13 to the output device 5.

The memory 12 has, for example, volatile semiconductor memories (e.g., DRAM (Dynamic Random Access Memory), SRAM (Static Random Access Memory), and the like), and non-volatile semiconductor memories (e.g., ROM (Read Only Memory), EEPROM (Electrically Erasable Programmable Read Only Memory), a flash memory, and the like). The memory 12 stores temporary data, a computer program (a control program of the ECU 10) used for various processes by the processor 13, setting data of the ECU 10, log data, vehicle-information, and the like.

The processor 13 has one or more CPU (Central Processing Unit) and its peripheral circuitry. The processor 13 executes a computer program stored in the memory 12. The processor 13 may further include other arithmetic circuits such as a logical arithmetic unit, a numerical arithmetic unit, or a graphic processing unit.

In the present embodiment, the ECU 10 functions as a warning device for notifying an occupant of the vehicle 1 of a warning. In particular, in the present embodiment, the ECU 10 notifies the occupant of the vehicle 1 of a warning if it is expected that the moving object on the rear-lateral side of the vehicle 1 comes into contact with the door of the vehicle 1 when the vehicle 1 is stopped. Accordingly, the ECU 10 assists the occupant of the vehicle 1 in getting off by notifying the occupant of the vehicle 1 of a warning. Note that the ECU 10 is merely an example of the warning device.

As shown in FIG. 1, the processor 13 of the ECU 10 has a region setting part 14 and a warning part 15. The region setting part 14 and the warning part 15 are functional modules realized by the processor 13 of the ECU 10 executing a computer program stored in the memory 12 of the ECU 10. Note that these functional modules may be realized by dedicated arithmetic circuits provided in the processor 13.

The region setting part 14 sets a warning target region on the rear-lateral side of the vehicle 1, and the warning part 15 notifies the occupant of the vehicle 1 of the warning when the moving object located in the warning target region set by the region setting part 14 is expected to come into contact with the door of the vehicle 1. The moving object is an object that may pass through the side of the vehicle 1 (host vehicle), and includes, for example, an automobile, a motorcycle, a bicycle, a pedestrian, and the like. In the present embodiment, the moving object is detected based on the output of the rear-lateral radar 2. Note that the moving object may be detected based on at least one of an image generated by a rear camera that captures the rear of the vehicle 1 and an output of a sonar (ultrasonic sensor) that transmits an ultrasonic wave to the rear of the vehicle 1, in addition to or instead of the output of the rear-lateral radar 2.

The region setting part 14 sets a predetermined area in the vehicle coordinate system based on the vehicle 1 to a warning target region. In the vehicle coordinate system, the X-axis represents the traveling direction (longitudinal direction) of the vehicle 1, and the Y-axis represents the width direction (lateral direction) of the vehicle 1 perpendicular to the traveling direction of the vehicle 1. In the present embodiment, the origin of the vehicle coordinate system is set to the right rear end point of the vehicle 1. Note that the origin of the vehicle coordinate system may be set to another position such as the center of the rear end of the vehicle 1.

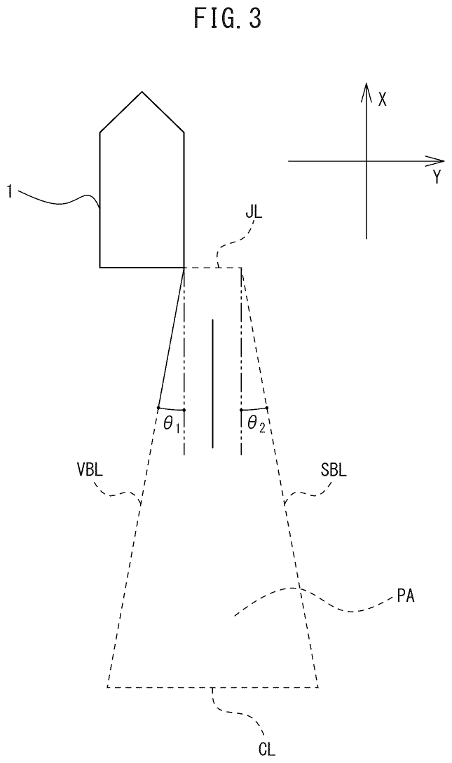

FIG. 3 is a diagram showing a predetermined area PA set to the warning target region. The predetermined area PA is set to the rear-lateral side of the vehicle 1, and is set to the right rear-lateral side of the vehicle 1 in the present embodiment. The predetermined area PA is defined by an intersection determination line JL, a vehicle side boundary line VBL, a space side boundary line SBL and a connection line CL, and the intersection determination line JL, the vehicle side boundary line VBL, the space side boundary line SBL, and the connection line CL form a square.

The intersection determination line JL extends away from the vehicle 1 in the width direction (Y-axis direction) of the vehicle 1. In the present embodiment, as shown in FIG. 3, the intersection determination line JL extends away from the vehicle 1 starting from the origin of the vehicle coordinate system, i.e., the right rear end point of the vehicle 1. That is, the end point on the vehicle 1 side of the intersection determination line JL corresponds to the right rear end point of the vehicle 1.

The vehicle side boundary line VBL is a side adjoining the intersection determination line JL and extends from the end point on the vehicle side 1 of the intersection determination line JL to the rear of the vehicle 1. In the present embodiment, the vehicle side boundary line VBL forms a first angle θ₁ with respect to the imaginary line parallel to the side surface of the vehicle 1 so that the moving object approaching the vehicle 1 in an oblique path also becomes a warning target. That is, the vehicle side boundary line VBL forms a first angle θ₁ with respect to the X-axis and extends obliquely rearward to the left.

The space side boundary line SBL is a side adjoining the intersection determination line JL and extends from an end point on the opposite side to the vehicle 1 of intersection determination line JL to the rear of the vehicle 1. In the present embodiment, the space side boundary line SBL forms a second angle θ₂ with respect to the imaginary line parallel to the side surface of the vehicle 1 so that the moving object approaching the vehicle 1 in an oblique path also becomes a warning target. That is, the space side boundary line SBL forms a second angle θ₂ with respect to the X-axis and extends obliquely rearward to the right. In the present embodiment, the lengths of the vehicle side boundary line VBL and the space side boundary line SBL are equal, and the absolute values of the first angle θ₁ and the second angle θ₂ are equal.

The connecting line CL is a side adjacent to the vehicle side boundary line VBL and the space side boundary line SBL, and connects an end point on the opposite side to the vehicle 1 of the vehicle side boundary line VBL and an end point on the opposite side to the vehicle 1 of the space side boundary line SBL. Since the vehicle side boundary line VBL and the space side boundary line SBL extend toward the rear of the vehicle 1 so that they are away from each other, the length of the connecting line CL is longer than the length of the intersection determination line JL. In the present embodiment, the intersection determination line JL and the connecting line CL which are a pair of opposite sides are parallel, and the intersection determination line JL, the vehicle side boundary line VBL, the space side boundary line SBL, and the connecting line CL form a trapezoid.

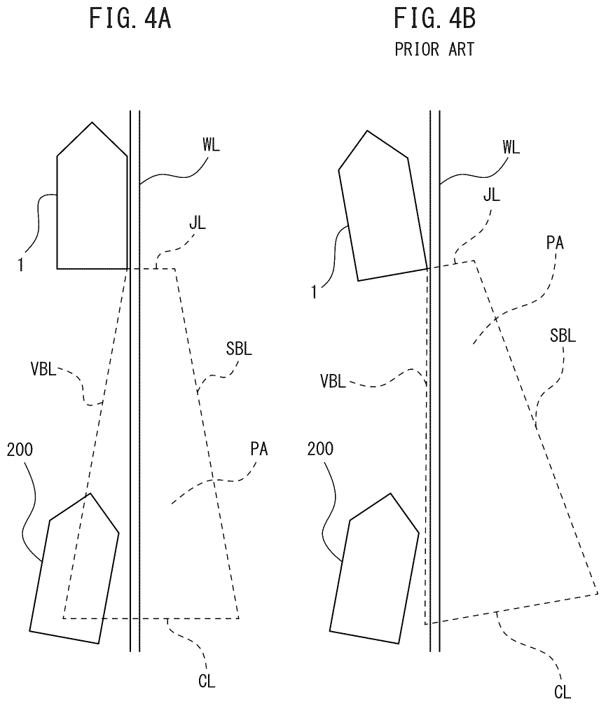

FIG. 4 is a diagram for explaining a problem that occurs when the vehicle 1 is obliquely stopped with respect to the white line WL of the road. In the diagram shown in FIG. 4A, the vehicles 1 is stopped parallel to the white line WL. That is, the traveling direction of the vehicles 1 coincides with the extending direction of the white line WL. In this case, the intersection determination line JL extends perpendicularly to the white line WL, and the vehicle side boundary line VBL extends obliquely to the white line WL. As a result, a part of the surrounding vehicle 200 located on the same side (left side) as the vehicle 1 with respect to the white line WL is included in the predetermined area PA, and the surrounding vehicle 200 becomes a warning target.

On the other hand, in the diagram shown in FIG. 4B, the vehicle 1 is obliquely stopped with respect to the white line WL. Specifically, the vehicle 1 is located on the left side of the white line WL, and is obliquely stopped with respect to the white line WL such that the front end portion of the vehicle 1 is away from the white line WL and the rear end portion of the vehicle 1 is close to the white line WL. In this case, since the predetermined area PA is determined with respect to the vehicle coordinate system, the position of the predetermined area PA with respect to the white line WL changes according to the stop angle of the vehicle 1. Specifically, the intersection determination line JL extends obliquely with respect to the white line WL, and the vehicle side boundary line VBL extends substantially parallel to the white line WL. As a result, the surrounding vehicle 200 located on the same side (left side) as the vehicle 1 with respect to the white line WL is not included in the predetermined area PA, and the surrounding vehicle 200 is excluded from the warning target. Accordingly, a moving object that may come into contact with the door of the vehicle 1 is excluded from the warning target.

In view of the above problem, in the present embodiment, the region setting part14 corrects the predetermined area PA set in the warning target region when the vehicle 1 is obliquely stopped with respect to the white line WL. As a result, it is possible to suppress the moving object that may come into contact with the door of the vehicle 1 from being excluded from the warning target when the vehicle 1 is obliquely stopped with respect to the white line WL.

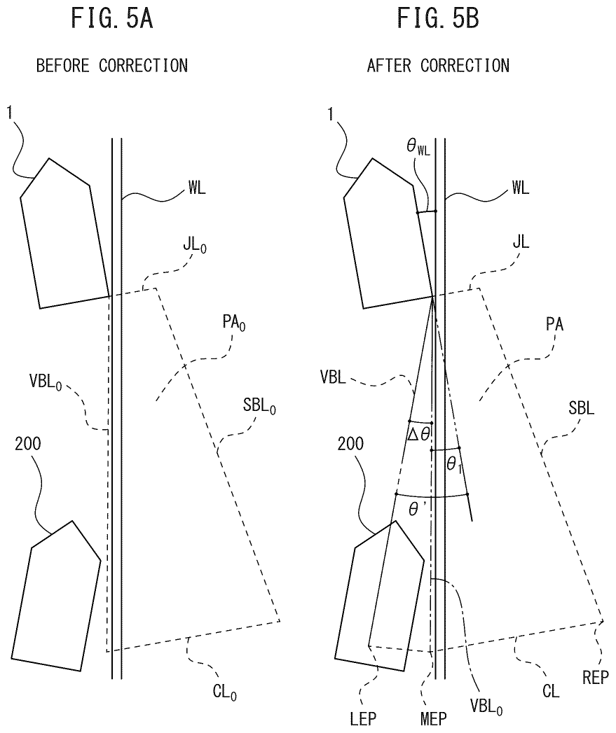

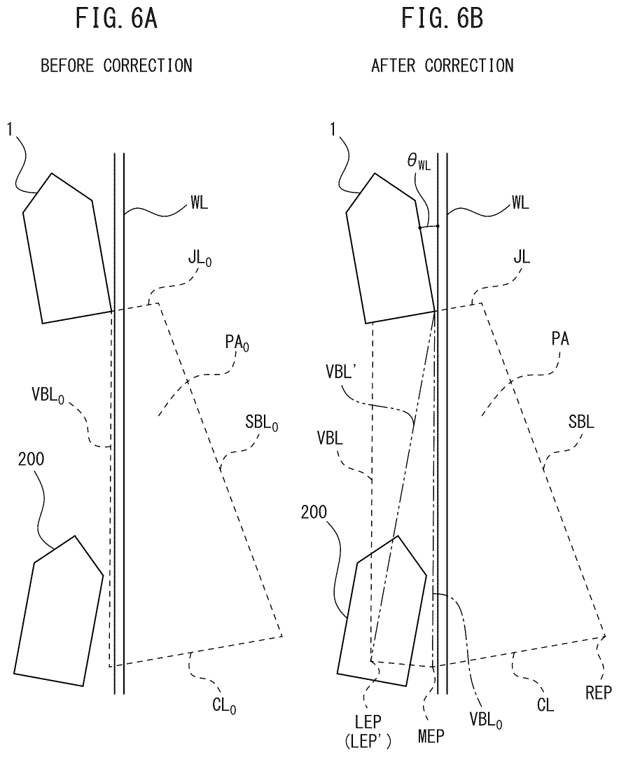

FIG. 5 to FIG. 7 are diagrams showing specific examples of a method of correcting the predetermined area PA. In the correction methods shown in FIG. 5 and FIG. 6, the region setting part 14 enlarges the predetermined area PA when the vehicle 1 is obliquely stopped with respect to the white line WL. As a result, even when the vehicle 1 is obliquely stopped with respect to the white line WL, a moving object that may come into contact with the door of the vehicle 1 can be included in the warning target region. Hereinafter, each correction method will be described in detail.

FIG. 5A is a diagram similar to FIG. 4B and the predetermined area PA₀ before correction is shown in FIG. 5A. On the other hand, FIG. 5B shows the corrected predetermined area PA, and the area of the corrected predetermined area PA is larger than the area of predetermined area PA₀ before correction. Note that in FIG. 5B, the vehicle side boundary line VBL₀ before correction that defines the predetermined area PA before correction is indicated by a dashed-dotted line.

In the correction method shown in FIG. 5B, the region setting part 14 enlarges the predetermined area PA so that the vehicle side boundary line VBL forms a correction angle θ′ larger than the first angle θ₁ with respect to the imaginary line IL parallel to the side surface of the vehicle 1, when the vehicle 1 is obliquely stopped with respect to the white line WL. As shown in FIG. 5B, the correction angle θ′ is the sum of the increment angle Δθ and the first angle θ₁. Accordingly, the region setting part 14 enlarges the predetermined area PA by rotating the vehicle side boundary line VBL₀ before correction clockwise by the increment angle Δθ with the origin of the vehicle coordinate system (in the present embodiment, the right rear end point of the vehicle 1) as a rotation center.

Further, the increment angle Δθ is set to be equal to or less than an angle θ_{WL} that the vehicle 1 forms with respect to the white line WL. By setting the increment angle Δθ to be equal to or less than the angle θ_{WL}, it is possible to prevent a moving object that is extremely unlikely to come into contact with the door of the vehicle 1 from being included in the warning target, while suppressing the moving object to be the warning target from being excluded from the warning target. Note that in the example of FIG. 5B, the increment angle Δθ is equal to the angle θ_{WL}.

FIG. 6A is a diagram similar to FIG. 4B and the predetermined area PA₀ before correction is shown in FIG. 6A. On the other hand, FIG. 6B shows the corrected predetermined area PA, and the area of the corrected predetermined area PA is larger than the area of predetermined area PA₀ before correction. Note that in FIG. 6B, the vehicle side boundary line VBL₀ before correction that defines the predetermined area PA before correction is indicated by a dashed line, and the vehicle side boundary line VBL′ when it is assumed that the vehicle 1 is stopped parallel to the white line WL is indicated by a double-dotted line. The position of the vehicle 1 when it is assumed that the vehicle 1 is stopped parallel to the white line WL is obtained by rotationally moving the vehicle 1 clockwise by an angle θ_{WL} with the origin of the vehicle coordinate system (in the present embodiment, the right rear end point of the vehicle 1) as a rotation center.

In the correction method shown in FIG. 6B, when the vehicle 1 is obliquely stopped with respect to the white line WL, the region setting part 14 extends the intersection determination line JL toward the vehicle 1 side so that the end point LEP on the opposite side to the vehicle 1 of the vehicle side boundary line VBL approaches the corresponding end point of the warning target area (the end point LEP′ on the opposite side to the vehicle 1 of vehicle side boundary line VBL′) when it is assumed that the vehicle 1 is stopped parallel to the white line WL. By enlarging predetermined area PA so that the end point LEP is located in the range up to the end point LEP′, it is possible to prevent a moving object that is unlikely to come into contact with the door of the vehicle 1 from being included in the warning target while suppressing the moving object to be the warning target from being excluded from the warning target. Note that in the example of FIG. 6B, the intersection determination line JL is extended toward the vehicle 1 side so that the end point LEP coincides with the end point LEP′.

In the correction method of FIG. 5B, the length of the vehicle side boundary line VBL is the same before and after the correction, while the angle that vehicle side boundary line VBL forms with respect to the intersection determination line JL differs before and after the correction. On the other hand, in the correction method of FIG. 6B, the angle that the vehicle side boundary line VBL forms with respect to the intersection determination line JL is the same before and after the correction, while the length of vehicle side boundary line VBL differs before and after the correction. In addition, in the correction method of FIG. 5B, the length of the intersection determination line JL is the same before and after the correction, while in the correction method of FIG. 6B, the length of the intersection determination line JL differs before and after the correction.

In the examples of FIG. 5B and FIG. 6B, the connecting line CL consists of a straight line connecting the end point LEP on the opposite side to the vehicle 1 of the corrected vehicle side boundary line VBL and the end point MEP on the opposite side to the vehicle 1 of the vehicle side boundary line VBL₀ before the correction, and a straight line connecting the end point MEP and the end point REP on the opposite side to the vehicle 1 of the space side boundary line SBL. However, the connecting line CL may be a line connecting the end point LEP and the end point RLP with a smooth curved line, a line connecting the end point LEP and the end point RLP with a straight line, or the like.

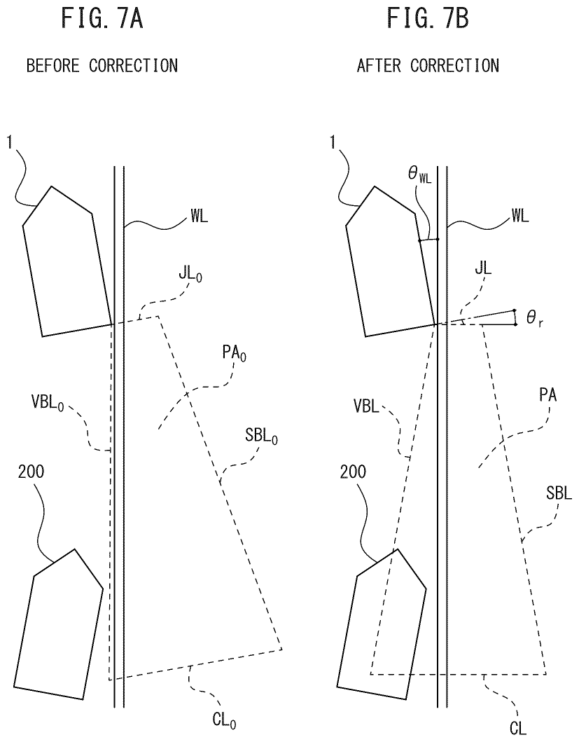

FIG. 7A is a diagram similar to FIG. 4B and the predetermined area PA₀ before correction is shown in FIG. 7A. On the other hand, FIG. 7B shows the corrected predetermined area PA. In the correction method shown in FIG. 7, the region setting part 14 corrects the predetermined area PA by changing the position of predetermined area PA without changing the area of predetermined area PA. Therefore, the area of the predetermined area PA after correction is equal to the area of the predetermined area PA₀ before correction.

When the vehicle 1 is obliquely stopped with respect to the white line WL, the region setting part 14 rotationally moves the predetermined area PA by a predetermined rotational angle θᵣ so that the predetermined area PA overlaps the warning target region when it is assumed that the vehicle 1 is stopped parallel to the white line WL. Specifically, the region setting part 14 rotationally moves the predetermined area PA by a predetermined rotational angle θᵣ with the origin of the vehicle coordinate system (in the present embodiment, the right rear end point of the vehicle 1) as a rotation center.

The predetermined rotational angle θr is set to be equal to or less than an angle θ_{WL} that the vehicle 1 forms with respect to the white line WL. As a result, it is possible to prevent a moving target that is extremely unlikely to come into contact with the door of the vehicle 1 from being included in the warning target, while suppressing the moving object to be the warning target from being excluded from the warning target. Note that in the example of FIG. 7B, the predetermined rotational angle θr is equal to the angular θ_{WL}, and the corrected predetermined area PA coincides with the warning target region when it is assumed that the vehicle 1 is stopped parallel to the white line WL.

As shown in FIG. 5 to FIG. 7, the surrounding vehicle 200 behind the vehicle 1 is located outside the predetermined area PA₀ before correction and inside the predetermined area PA after correction. Accordingly, by correcting the predetermined area PA using the correction methods as shown in FIG. 5 to FIG. 7, the surrounding vehicle 200 that may come into contact with the door of the vehicle 1 can be included in the warning target region.

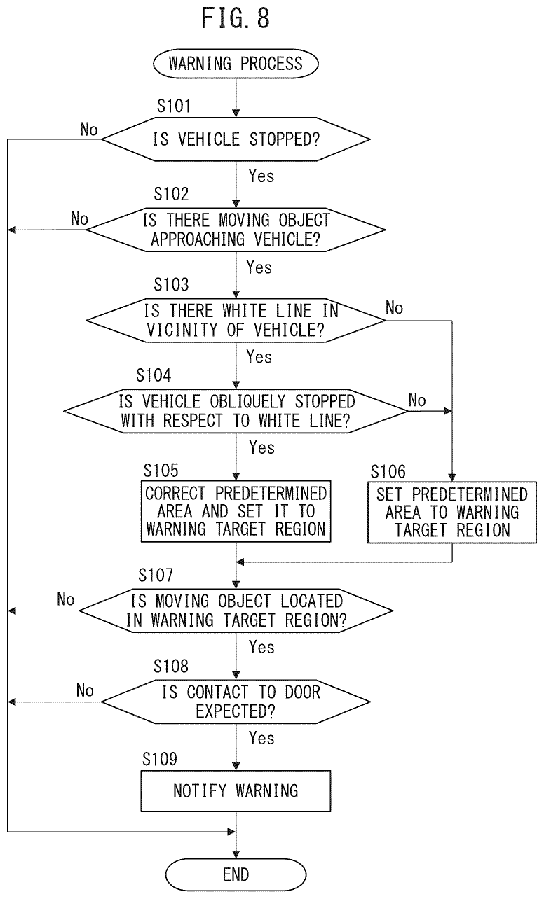

Hereinafter, the flow of the process for executing the above-described control will be described by referring to FIG. 8. FIG. 8 is a flow chart showing a control routine related to the warning process in the present embodiment. The present control routine is repeatedly executed by the processor 13 of the ECU 10, for example, in accordance with a computer program stored in the memory 12 of the ECU 10.

First, in step S101, the warning part 15 of the processor 13 determines whether or not the vehicle 1 is stopped. For example, the warning part 15 determines whether or not the vehicle 1 is stopped based on the output of the vehicle speed sensor 4. In this case, the warning part 15 determines that the vehicle 1 is stopped when the speed of the vehicle 1 detected by the vehicle speed sensor 4 is zero. If it is determined that the vehicle 1 is not stopped, the present control routine ends. On the other hand, if it is determined that the vehicle 1 is stopped, the present control routine proceeds to step S102.

In step S102, the warning part 15 determines whether or not there is a moving object approaching the vehicle 1. For example, the warning part 15 determines whether or not there is a moving object based on the output of the rear-lateral radar 2. If it is determined that there is no moving object, the present control routine ends. On the other hand, if it is determined that there is a moving object, the present control routine proceeds to step S103.

In the step S103, the region setting part 14 of the processor 13 determines whether or not there is a white line WL in the vicinity of the vehicle 1. For example, the region setting part 14 detects the presence or absence of a white line WL using an image-analysis technique, such as a machine learning model, based on the output of the front camera 3. If it is determined that there is a white line WL, the present control routine proceeds to step S104.

In step S104, the region setting part 14 determines whether or not the vehicle 1 is obliquely stopped with respect to the white line WL. For example, the region setting part 14 detects the position of the white line WL relative to the vehicle 1 using an image-analysis technique such as a machine learning model based on the output of the front camera 3. If it is determined that the vehicle 1 is obliquely stopped with respect to the white line WL, the present control routine proceeds to step S105.

In step S105, the region setting part 14 corrects the predetermined area PA and sets the corrected predetermined area PA to the warning target region. The region setting part 14 uses any one of the correction methods shown in, for example, FIG. 5 to FIG. 7 when correcting the predetermined area PA.

On the other hand, if it is determined in step S103 that there is no white line WL, or if it is determined in step S104 that the vehicle 1 is stopped parallel to the white line WL, the present control routine proceeds to step S106. In step S106, the region setting part 14 sets the predetermined area PA to the warning target region without correcting the predetermined area PA.

After step S105 or S106, the present control routine proceeds to step S107. In step S107, the warning part 15 determines whether or not the moving object is located in the warning target region set in step S105 or S106. In the present embodiment, when at least a part of the moving object is included in the warning target region, the warning part 15 determines that the moving object is located in the warning target region. If it is determined that the moving object is not located in the warning target region, the present control routine ends. On the other hand, if it is determined that the moving object is located in the warning target region, the present control routine proceeds to step S108.

In step S108, the warning part 15 determines whether or not the moving object is expected to come into contact with the door of the vehicle 1. For example, the warning part 15 determines whether or not the moving object is expected to come into contact with the door of the vehicle 1 based on the velocity of the moving object, the moving direction of the moving object, the opening/closing state of the door of the vehicle 1, and the like. If it is determined that no contact to the door is expected, the present control routine ends. On the other hand, if the moving object is expected to come into contact with the door of the vehicle 1, the present control routine proceeds to step S109.

In step S109, the warning part 15 notifies the occupant (for example, the driver) of the vehicle 1 of the warning via the output device 5. For example, the warning part 15 notifies the occupant of the vehicle 1 of at least one of a visual warning via a display or a warning light of the output device 5 and an audible warning via a speaker or a buzzer of the output device 5. After step S109, the control routine ends.

Note that step S108 may be omitted. That is, the warning part 15 may determine that the moving object is expected to come into contact with the door with the fact that the moving object is located in the warning target region. Further, in step S107, the warning part 15 may determine that the moving object is not included in the warning target region when the ratio of the moving object included in the warning target region (overlapping with the warning target region) is equal to or less than a predetermined value (for example, 10% to 40%).

While preferred embodiments of the present disclosure have been described above, the present disclosure is not limited to these embodiments, and various modifications and changes can be made within the scope of the claims. For example, the region setting part 14 may determine that the vehicle 1 is obliquely stopped with respect to the white line WL when the angle that the vehicle 1 forms with respect to the white line WL is equal to or greater than a predetermined value (for example, 5° to 10°), and may determine that the vehicle 1 is stopped parallel to the white line WL when the angle that the vehicle 1 forms with respect to the white line WL is less than the predetermined value.

Further, in the above-described embodiment, although the description has been made assuming the vehicle 1 of the right steering wheel traveling on the road of the left side passage, the present disclosure is also applicable to the vehicle 1 of the left steering wheel traveling on the road of the right side passage. In this case, for example, the predetermined area PA is set to the left rear-lateral side of the vehicle 1, and the origin of the vehicle coordinate system is set to the left rear end point of the vehicle 1. Further, the position of the vehicle 1 when it is assumed that the vehicle 1 is stopped parallel to the white line WL is obtained by rotationally moving the vehicle 1, which is obliquely stopped with respect to the white line WL, counterclockwise by an angle θ_{WL} with the origin of the vehicle coordinate system as a rotation center.

Further, a computer program that causes a computer to realize the functions of the respective parts included in the processor 13 of the ECU 10 may be provided in a form stored in a computer-readable recording medium or a form included in a computer program product. The computer-readable recording medium is, for example, a magnetic recording medium, an optical recording medium, or a semiconductor memory.

1. A warning device comprising a processor configured to:
set a warning target region on a rear-lateral side of a vehicle; and
notify an occupant of the vehicle of a warning when a moving object located in the warning target region is expected to come into contact with a door of the vehicle, wherein
the processor is configured to set a predetermined area in a vehicle coordinate system based on the vehicle to the warning target region, and correct the predetermined area when the vehicle is obliquely stopped with respect to a white line of a road.

2. The warning device according to claim 1, wherein the processor is configured to enlarge the predetermined area when the vehicle is obliquely stopped with respect to the white line.

3. The warning device according to claim 2, wherein
the predetermined area is defined by a vehicle side boundary line forming a predetermined angle with respect to an imaginary line parallel to a side surface of the vehicle,
the processor is configured to enlarge the predetermined area so that the vehicle side boundary line forms a correction angle larger than the predetermined angle with respect to the imaginary line when the vehicle is obliquely stopped with respect to the white line, and
the correction angle is a sum of an increment angle equal to or less than an angle that the vehicle forms with respect to the white line, and the predetermined angle.

4. The warning device according to claim 2, wherein
the predetermined area is defined by an intersection determination line extending away from the vehicle in a width direction of the vehicle, and a vehicle side boundary line extending from an end point on the vehicle side of the intersection determination line to a rear of the vehicle, and
when the vehicle is obliquely stopped with respect to the white line, the processor is configured to extend the intersection determination line toward the vehicle side so that an end point on an opposite side to the vehicle of the vehicle side boundary line approaches a corresponding end point of the warning target region when it is assumed that the vehicle is stopped parallel to the white line.

5. The warning device according to claim 1, wherein
when the vehicle is obliquely stopped with respect to the white line, the processor is configured to rotationally move the predetermined area by a predetermined rotation angle so that the predetermined area overlaps with the warning target region when it is assumed that the vehicle is stopped parallel to the white line, and
the rotation angle is equal to or less than an angle that the vehicle forms with respect to the white line.
